(19) United States
(12) Patent Application Publication
(10) Pub. No.: US 2026/0204000 A1
(43) Pub. Date: Jul. 16, 2026

(54) SUPPORTING MULTI-VIEW AND MULTI-CHANNEL CONTENT IN THREE-DIMENSIONAL (3D) SCENES

(71) Applicant: QUALCOMM Incorporated, San Diego, CA (US)

(72) Inventors: Imed Bouazizi, Celina, TX (US); Thomas Stockhammer, Bergen (DE)

(21) Appl. No.: 19/447,948

(22) Filed: Jan. 13, 2026

Related U.S. Application Data
(60) Provisional application No. 63/745,437, filed on Jan. 15, 2025.

(51) Int. Cl. G06T 15/20; G06T 7/55; H04L 65/70; H04S 3/00; H04S 7/00

(52) U.S. Cl. CPC G06T 15/20; G06T 7/55; H04L 65/70; H04S 3/008; H04S 7/303; G06T 2207/10021; G06T 2207/20228; G06T 2210/61; H04S 2400/01; H04S 2400/11

(57) ABSTRACT

An example device for communicating media data includes: a memory configured to store spatial media data; and a processing system implemented in circuitry and configured to: receive the spatial media data, the spatial media data including two or more channels including spatially distinct data for each presentation time instance; receive a scene description including data describing a virtual scene, the scene description further including data grouping the spatially distinct data of the spatial media data and data for characteristics of the spatially distinct data; determine a position of a user in the virtual scene; and present one or more of the spatially distinct data to the user according to the position of the user in the virtual scene.

This application claims the benefit of U.S. Provisional Application No. 63/745,437, filed Jan. 15, 2025, the entire contents of which are hereby incorporated by reference.

### TECHNICAL FIELD

This disclosure relates to transport of media data, and more particularly, to transport of augmented reality media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

After media data has been encoded, the media data may be packetized for transmission or storage. The video data may be assembled into a media file conforming to any of a variety of standards, such as the International Organization for Standardization (ISO) base media file format and extensions thereof.

### SUMMARY

In general, this disclosure describes techniques for exchanging augmented reality (AR) media data. AR media data may include, for example, extended reality (XR) media data, mixed reality (MR) media data, or virtual reality (VR) media data. Such media data may be exchanged during an AR session including one or more participants, e.g., for AR gaming sessions, AR conference calls, or the like. In some cases, a content preparer may wish to present a virtual scene including mixed media types. For example, the scene may include a virtual movie theater that presents a spatial video. The content preparer, which may be a user, may capture the spatial video to be presented using a camera, such as a camera on a smartphone. The content preparer may then use an editing tool to create a complete three-dimensional (3D) virtual experience, e.g., presenting a scene including the virtual movie theater with a virtual screen that plays the spatial video. The user may then share the 3D scene including the spatial video with their friends, who can experience the scene on respective head mounted displays (HMDs). The spatial video may be configured to render different perspectives based upon chosen seats in the virtual theater.

This disclosure describes various techniques that may support such a use case, such as signaling a grouping of multiple video textures and characteristics of the multiple video textures. Multi-channel audio may also be rendered, where an audio source may provide a transform matrix that maps a graph node of an audio source to a speaker layer, thereby creating a virtual placement of loudspeakers in the 3D scene. Thus, the techniques of this disclosure generally include techniques for supporting communication of multi-channel media data (e.g., audio and/or video data), which may allow for rendering of media data from the perspectives of multiple different users in a virtual environment.

In one example, a method of communicating media data includes: obtaining spatial media data including two or more channels including spatially distinct data for each presentation time instance; generating a scene description including data describing a virtual scene, the scene description further including data grouping the spatially distinct data of the spatial media data and data for characteristics of the spatially distinct data; and sending the scene description and the spatial media data to a receiver device.

In another example, a device for communicating media data includes: a memory configured to store spatial media data; and a processing system implemented in circuitry and configured to: obtain the spatial media data, the spatial media data including two or more channels including spatially distinct data for each presentation time instance; generate a scene description including data describing a virtual scene, the scene description further including data grouping the spatially distinct data of the spatial media data and data for characteristics of the spatially distinct data; and send the scene description and the spatial media data to a receiver device.

In another example, a method of communicating media data includes: receiving spatial media data including two or more channels including spatially distinct data for each presentation time instance; receiving a scene description including data describing a virtual scene, the scene description further including data grouping the spatially distinct data of the spatial media data and data for characteristics of the spatially distinct data; determining a position of a user in the virtual scene; and presenting one or more of the spatially distinct data to the user according to the position of the user in the virtual scene.

In another example, a device for communicating media data includes: a memory configured to store spatial media data; and a processing system implemented in circuitry and configured to: receive the spatial media data, the spatial media data including two or more channels including spatially distinct data for each presentation time instance; receive a scene description including data describing a virtual scene, the scene description further including data grouping the spatially distinct data of the spatial media data and data for characteristics of the spatially distinct data; determine a position of a user in the virtual scene; and present one or more of the spatially distinct data to the user according to the position of the user in the virtual scene.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example network including various devices for performing the techniques of this disclosure.

FIG. 2 is a block diagram illustrating an example computing system that may perform split rendering techniques of this disclosure.

FIG. 3 is a block diagram illustrating an example content preparation device according to techniques of this disclosure.

FIG. 4 is a block diagram illustrating an example content preparation device that may perform techniques of this disclosure.

FIG. 5 is a block diagram illustrating an example presentation device that may perform techniques of this disclosure.

FIG. 6 is a block diagram illustrating another example presentation device that may perform techniques of this disclosure.

FIG. 7 is a flowchart illustrating an example method of preparing and sending a scene description for multi-channel media data to a receiving device according to techniques of this disclosure.

FIG. 8 is a flowchart illustrating an example method of receiving multi-channel media data and a scene description for the multi-channel media data and rendering output media data based on a position of a user in a virtual scene according to techniques of this disclosure.

### DETAILED DESCRIPTION

In general, this disclosure describes techniques for performing split rendering of augmented reality (AR) media data or other extended reality (XR) media data, such as mixed reality (MR) or virtual reality (VR). A user or other content preparer may capture or generate a spatial video to be presented as part of a virtual scene in an AR session, e.g., pre-recorded, live, or on-demand. For example, the content preparer may generate a virtual movie theater including a screen that is to be used to present the spatial video. Perspectives of the spatial video may differ based upon a viewer's position in the virtual movie theater, e.g., based upon a chosen seat. Therefore, both audio and video data for the spatial video may differ according to the viewer's position.

An MPEG scene description includes video texture support for two-dimensional (2D) video data. For example, a Graphics Library Transmission Format (glTF) 2.0 MPEG texture video may be described according to the following elements:

| | | De- | Us- | |
|---|---|---|---|---|
| Name | Type | fault | age | Description |
| accessor | integer | N/A | M | Provides a reference to the accessor, by |
| | | | | specifying the accessor's index in |
| | | | | accessors array, that describes the buffer |
| | | | | where the decoded timed texture will be |
| | | | | made available. |
| | | | | The accessor shall have the |
| | | | | MPEG_accessor_timed extension. |
| | | | | The type, componentType, and count of |
| | | | | the accessor depend on the width, |
| | | | | height, and format |
| width | integer | N/A | M | Provides the maximum width of the |
| | | | | texture. |
| height | integer | N/A | M | Provides the maximum height of the |
| | | | | texture. |
| format | string | RGB | O | Indicates the format of the pixel data for |
| | | | | this video texture. The allowed values |
| | | | | may include, for example: RED, |
| | | | | GREEN, BLUE, RG, RGB, RGBA, |
| | | | | BGR, BGRA, |
| | | | | DEPTH_COMPONENT. |
| | | | | Example semantics of these values |
| | | | | are defined in Table 8.3 of OpenGL ® |
| | | | | specification. Additionally, YCbCr |
| | | | | formats are supported. The semantics |
| | | | | for the YCbCr formats are defined |
| | | | | in Table 76 in the Vulkan |
| | | | | specification. A sampler with |
| | | | | the MPEG_sampler_YCbCr extension |
| | | | | shall be linked to a YCbCr texture. |
| | | | | Note that the number of components |
| | | | | shall match the type indicated by the |
| | | | | referenced accessor. Normalization of |
| | | | | the pixel data shall be indicated by the |
| | | | | normalized attribute of the accessor. |

OpenGL® and the oval logo are trademarks or registered trademarks of Hewlett Packard Enterprise in the United States and/or other countries worldwide. OpenGL® is one example of a specification that may be used to provide semantics for the format element. Other standards or techniques may be used as alternatives. The semantics for the YCbCr formats may be as defined in Table 76 in the Vulkan 1.3 specification. A sampler with the MPEG_sampler_YCbCr extension may be linked to a YCbCr texture.

To support stereo and multi-view video in 3D scenes per techniques of this disclosure, an MPEG texture video attribute may signal a grouping of multiple video textures and also describe characteristics of the multiple video textures. A first video texture may be marked as a primary view. The MPEG video texture may be extended, per techniques of this disclosure, to allow for multiple output buffers, one output buffer for each view. A scene description, per techniques of this disclosure, may include a grouping of multiple MPEG_texture_video extensions to the texture element to be part of the same group of type “multi-view” or “stereo.” In addition, each view may include metadata that describes that view to enable proper processing and rendering. This allows for reprojection of the view to match a viewer's pose and interpupillary distance. Intrinsic camera parameters may include a 3×3 matrix, focal_length, principal_point, and skew_factor. Extrinsic capture camera parameters may include translation and rotation. This also allows for masking certain views depending on the target eye, e.g., left/right eye. Thus, a target_eye or mask attribute may be signaled indicating, e.g., EYE_LEFT, EYE_RIGHT, or EYE_BOTH.

In some examples, the designation of the primary view is determined by the order of the video textures within the group. For instance, the video texture appearing first in the grouping list or array may be designated as the primary view by default. This ordering may enable legacy receivers, which may not support multi-view processing, to simply decode and render the first texture encountered as a standard 2D video, while receivers configured according to the techniques of this disclosure may process subsequent textures for stereo or multi-view rendering.

This ordering may enable legacy receivers, which may not support multi-view processing, to simply decode and render the first texture encountered as a standard 2D video. For example, if the spatial video is encoded using Multi-View High Efficiency Video Coding (MV-HEVC), a legacy receiver incapable of processing the additional view layers may default to decoding the base layer (the primary view) located first in the bitstream or grouping list. Receivers configured according to the techniques of this disclosure, such as presentation device 300, may recognize the grouping metadata and process the subsequent textures to render the full stereo or multi-view experience.

Syntax of the extended MPEG_texture_video may be as follows, as one example, per techniques of this disclosure:

| | | | | |
|---|---|---|---|---|
| | | De- | Us- | |
| Name | Type | fault | age | Description |

| | | | |
|---|---|---|---|
| extras | | | Extensions go into extras element |
| | | | of MPEG_texture_video |
| | | | extension |
| group_id | number | M | A group identifier that indicates |
| | | | that multiple video textures are |
| | | | associated together |
| group_type | Enum | M | Indicates the type of the group, |
| | | | e.g., “stereo” or |
| | | | “multi-view” type. |
| camera | Object | M | Intrinsic and extrinsic camera |
| | | | parameters object, that is assumed |
| | | | to be the target for rendering |
| | | | the content |
| mask | Enum | O | Mask that indicates to which eye |
| | | | this video texture is visible |

The camera object above may correspond to an ideal position or capture origin point (e.g., a center seat of a virtual theater). By signaling this ideal position via the intrinsic and extrinsic parameters of the camera object, a receiving device can calculate the deviation of the actual current position of a user in the virtual scene from the ideal position. This deviation calculation enables the receiving device to accurately perform the reprojection techniques described herein to correct the view for the actual perspective of the user. Thus, a receiving device may generate audio and/or video data for other positions as well, based on the position of a user in a virtual scene.

For example, the scene may include a virtual movie theater that presents a spatial video. The content preparer, which may be a user, may capture the spatial video to be presented using a camera. While a smartphone camera is one example, the content preparation device 200 may utilize various capture devices, including but not limited to stereoscopic cameras integrated into a head-mounted display (HMD), a tablet computer with depth-sensing capabilities, or a dedicated spatial video camera rig.

In some cases, the same media source and track include each of the views. For example, a multi-view High Efficiency Video Coding (MV-HEVC) bitstream may include each additional view along with a base view in the same bitstream using layered HEVC. The MPEG media_extension may be modified to add the layer identifier under alternatives in the track. This allows access to different layers of the same track. The tracks array in the MPEG_buffer_circular may also include layer identifiers. Additionally or alternatively, a notation track_id: layer_id may enhance the track_id signaling, where the layer_id value may be optional. The following table represents an example, where the “layers” value is added relative to existing signaling data:

| | | De- | Us- | |
|---|---|---|---|---|
| Name | Type | fault | age | Description |
| track | string | N/A | M | URL fragment to access the track |
| | | | | within the media alternative. |
| | | | | The URL structure is defined for |
| | | | | the following formats: |
| | | | | DASH: Using MPD Anchors (URL |
| | | | | fragments) as defined in ISO/IEC |
| | | | | 23009-1: 2022, Annex C (Table C.1) |
| | | | | ISO BMFF: URL fragments as |
| | | | | specified in ISO/IEC 14496-12: |
| | | | | 2022, Annex C. |
| | | | | SDP: stream identifier of the media |
| | | | | stream as defined in Annex C. |
| | | | | When V3C data is referenced in |
| | | | | the scene description document |
| | | | | as an item in |
| | | | | MPE_media.alternative.tracks |
| | | | | and the referenced item corresponds |
| | | | | to an ISOBMFF track, the following |
| | | | | applies: |
| | | | | For single-track encapsulated V3C |
| | | | | data, the referenced track in |
| | | | | MPEG_media shall be the V3C |
| | | | | bitstream track. |
| | | | | For multi-track encapsulated V3C |
| | | | | data, the referenced track in |
| | | | | MPEG_media shall be the V3C atlas |
| | | | | track. |
| layers | array(int) | N/A | O | A list of the layer identifiers for the |
| | | | | layers that are to be selected by this |
| | | | | alternative. |
| codecs | string | N/A | M | The codecs parameter, as defined in |
| | | | | RFC 6381, of the media included in |
| | | | | the track. When the track includes |
| | | | | different types of codecs (e.g., the |
| | | | | AdaptationSet includes Repre- |
| | | | | sentations with different codecs), |
| | | | | the codecs parameter may be |
| | | | | signaled by a comma-separated |
| | | | | list of values of the codecs. |

By employing this mapping, the single audio source node may effectively be replaced by the virtual speaker arrangement defined by the transform matrix and the channel type. Rather than rendering the audio as a single point source at the node location, the techniques of this disclosure may be used to distribute the audio data to the calculated virtual positions (e.g., the left and right virtual speakers for stereo), thereby allowing for a volumetric or spatial audio presentation that aligns with the multi-view video content.

To render multi-channel audio sources, the audio source of the MPEG_audio_spatial extension may provide a transform matrix that maps a graph node of the audio source to a speaker layer, thereby effectively creating a virtual spatial placement of a loudspeaker in the 3D scene. A single source node may be mapped to one or more real world speakers, e.g., a stereo speaker arrangement or multi-speaker array arrangement, such as 3.1, 5.1, or 7.1 surround sound. Source types may include “channels” type data. If the type is set to “channels,” a transform matrix T_{mapping} may be included in the scene description, where T_{mapping} is applied to the spatial speaker layout to determine the position of each speaker in the 3D scene, e.g., according to:

$${T}_{speaker\_i} = {T}_{source\_node} * {T}_{mapping} * {M}_{i}$$

The transform matrix T_{mapping} may be used to perform translation and/or rotation for virtual speaker positioning. That is, the transform matrix may encapsulate translation and rotation values to position virtual speakers relative to graph nodes represented by T_{source_node}. This may allow for precise spatial placement of the virtual speakers (e.g., defining the spread of the stereo pair or the radius and angles of a surround sound array) relative to the audio source's anchor in the virtual environment. By applying the translation and rotation components of the transform matrix, the rendering unit may establish the specific coordinates for each virtual speaker within the virtual scene. The scene description may further include an optional mask for masking channels to the left or right ear.

A rendering unit may implement viewpoint adjustment prior to rendering the content of a multi-view/multi-channel source. For textures, this may involve a process such as: disparity estimation, depth map refinement, 3D reconstruction, and reprojection. A current pose of the viewer may be periodically provided as input to the rendering unit. The rendering unit may also receive camera intrinsic and extrinsic parameters as input. Thus, the rendering unit may use this received input to reproject the view according to the viewer's position in the virtual scene.

For audio, the audio rendering process may include adjusting the channel sources to the virtual layout. This may include artificially delaying some channel streams to accommodate the changed distance between the virtual audio source and the position of the user. Additionally, virtual scene rendering unit 306 or 356 may apply environmental audio effects, such as reverberation, to the audio data. This processing simulates the acoustic characteristics of the virtual environment (e.g., the acoustics of a large virtual movie theater) as the audio travels from the virtual source location to the listener, further enhancing the immersion of the 3D scene. By dynamically adjusting channel delays and positions relative to the location of the user in the virtual scene, the techniques of this disclosure may maintain precise synchronization between the visual depth cues and the acoustic environment. This may ensure that the auditory experience accurately reflects the movement of the user within the SixDegrees of Freedom (6DoF) environment, thereby preserving spatial realism and preventing sensory mismatch between the re-projected video views and the perceived audio source locations.

A split rendering server may perform at least part of a rendering process to form rendered images, then stream the rendered images to a display device, such as AR glasses or a head mounted display (HMD). In general, a user may wear the display device, and the display device may capture pose information, such as a user position and orientation/rotation in real world space, which may be translated to render images for a viewport in a virtual world space.

Split rendering may enhance a user experience through providing access to advanced and sophisticated rendering that otherwise may not be possible or may place excess power and/or processing demands on AR glasses or a user equipment (UE) device. In split rendering all or parts of the 3D scene are rendered remotely on an edge application server, also referred to as a “split rendering server” in this disclosure. The results of the split rendering process are streamed down to the UE or AR glasses for display. The spectrum of split rendering operations may be wide, ranging from full pre-rendering on the edge to offloading partial, processing-extensive rendering operations to the edge.

The display device (e.g., UE/AR glasses) may stream pose predictions to the split rendering server at the edge. The display device may then receive rendered media for display from the split rendering server. The XR runtime may be configured to receive rendered data together with associated pose information (e.g., information indicating the predicted pose for which the rendered data was rendered) for proper composition and display. For instance, the XR runtime may perform pose correction to modify the rendered data according to an actual pose of the user at the display time. This disclosure describes techniques for conveying render pose information together with rendered images, e.g., in the form of a Real-time Transport Protocol (RTP) header extension. In this manner, the display device can accurately correct and display rendered images when the images were rendered by a separate device, e.g., for split rendering. This may allow advanced rendering techniques to be performed by the split rendering server while also presenting images that accurately reflect a user pose (e.g., position and orientation/rotation) to the user.

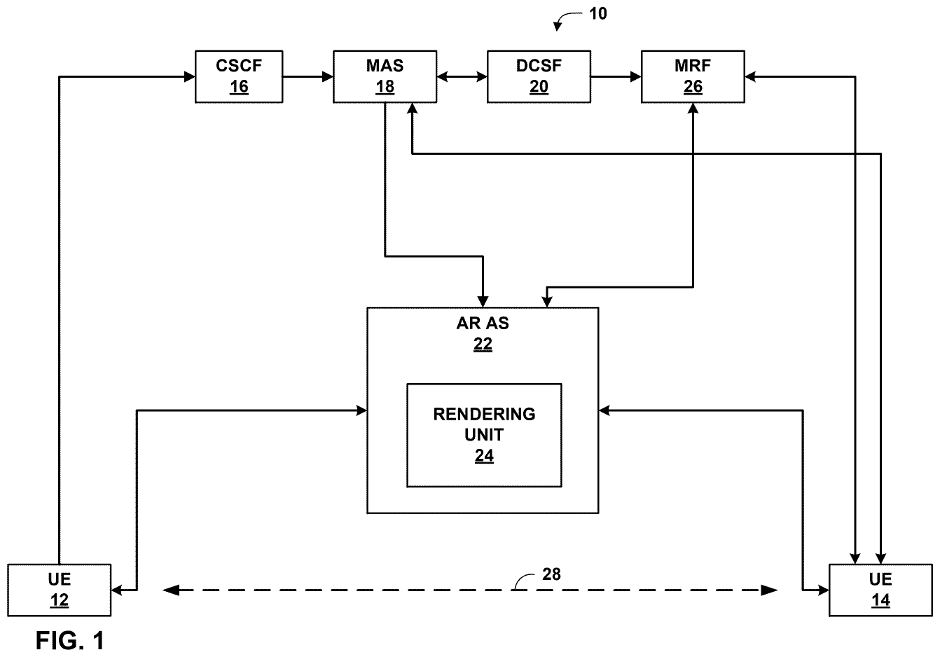

FIG. 1 is a block diagram illustrating an example network 10 including various devices for performing the techniques of this disclosure. In this example, network 10 includes user equipment (UE) devices 12, 14, call session control function (CSCF) 16, multimedia application server (MAS) 18, data channel signaling function (DCSF) 20, multimedia resource function (MRF) 26, and augmented reality application server (AR AS) 22. MAS 18 may correspond to a multimedia telephony application server, an IP Multimedia Subsystem (IMS) application server, or the like.

UEs 12, 14 represent examples of UEs that may participate in an AR communication session 28. AR communication session 28 may generally represent a communication session during which users of UEs 12, 14 exchange voice, video, and/or AR data (and/or other XR data). For example, AR communication session 28 may represent a conference call during which the users of UEs 12, 14 may be virtually present in a virtual conference room, which may include a virtual table, virtual chairs, a virtual screen or white board, or other such virtual objects. The users may be represented by avatars, which may be realistic or cartoonish depictions of the users in the virtual AR scene. The users may interact with virtual objects, which may cause the virtual objects to move or trigger other behaviors in the virtual scene. Furthermore, the users may navigate through the virtual scene, and a user's corresponding avatar may move according to the user's movements or movement inputs. In some examples, the users' avatars may include faces that are animated according to the facial movements of the users (e.g., to represent speech or emotions, e.g., smiling, thinking, frowning, or the like).

UEs 12, 14 may exchange AR media data related to a virtual scene, represented by a scene description. Users of UEs 12, 14 may view the virtual scene including virtual objects, as well as user AR data, such as avatars, shadows cast by the avatars, user virtual objects, user provided documents such as slides, images, videos, or the like, or other such data. Ultimately, users of UEs 12, 14 may experience an AR call from the perspective of their corresponding avatars (in first or third person) of virtual objects and avatars in the scene. In accordance with the techniques of this disclosure, UEs 12, 14 may obtain spatial media data including two or more channels. These two or more channels may include spatially distinct data for each presentation time instance. For example, the spatially distinct data for each presentation time instance may include two or more texture frames representing different perspectives of a common video presentation. UEs 12, 14 may capture this spatial video using one or more cameras, generate the spatial video, or retrieve the spatial video.

UEs 12, 14 may collect pose data for users of UEs 12, 14, respectively. For example, UEs 12, 14 may collect pose data including a position of the users, corresponding to positions within the virtual scene, as well as an orientation of a viewport, such as a direction in which the users are looking (i.e., an orientation of UEs 12, 14 in the real world, corresponding to virtual camera orientations). UEs 12, 14 may provide this pose data to AR AS 22 and/or to each other.

CSCF 16 may be a proxy CSCF (P-CSCF), an interrogating CSCF (I-CSCF), or serving CSCF (S-CSCF). CSCF 16 may generally authenticate users of UEs 12 and/or 14, inspect signaling for proper use, provide quality of service (QoS), provide policy enforcement, participate in session initiation protocol (SIP) communications, provide session control, direct messages to appropriate application server(s), provide routing services, or the like. CSCF 16 may represent one or more I/S/P CSCFs.

MAS 18 represents an application server for providing voice, video, and other telephony services over a network, such as a 5G network. MAS 18 may provide telephony applications and multimedia functions to UEs 12, 14.

DCSF 20 may act as an interface between MAS 18 and MRF 26, to request data channel resources from MRF 26 and to confirm that data channel resources have been allocated. DCSF 20 may receive event reports from MAS 18 and determine whether an AR communication service is permitted to be present during a communication session (e.g., an IMS communication session).

MRF 26 may be an enhanced MRF (eMRF) in some examples. In general, MRF 26 generates scene descriptions for each participant in an AR communication session. MRF 26 may support an AR conversational service, e.g., including providing transcoding for terminals with limited capabilities. MRF 26 may collect spatial and media descriptions from UEs 12, 14 and create scene descriptions for symmetrical AR call experiences. In some examples, rendering unit 24 may be included in MRF 26 instead of AR AS 22, such that MRF 26 may provide remote AR rendering services, as discussed in greater detail below.

MRF 26 may request data from UEs 12, 14 to create a symmetric experience for users of UEs 12, 14. The requested data may include, for example, a spatial description of a space around UEs 12, 14; media properties representing AR media that each of UEs 12, 14 will be sending to be incorporated into the scene; receiving media capabilities of UEs 12, 14 (e.g., decoding and rendering/hardware capabilities, such as a display resolution); and information based on detecting location, orientation, and capabilities of physical world devices that may be used in audio-visual communication sessions. Based on this data, MRF 26 may create a scene that defines placement of each user and AR media in the scene (e.g., position, size, depth from the user, anchor type, and recommended resolution/quality); and specific rendering properties for AR media data (e.g., if 2D media should be rendered with a “billboarding” effect such that the 2D media is always facing the user). MRF 26 may send the scene data to each of UEs 12, 14 using a supported scene description format.

AR AS 22 may participate in AR communication session 28. For example, AR AS 22 may provide AR service control related to AR communication session 28. AR service control may include AR session media control and AR media capability negotiation between UEs 12, 14 and rendering unit 24.

AR AS 22 also includes rendering unit 24, in this example. Rendering unit 24 may perform split rendering on behalf of at least one of UEs 12, 14. In some examples, two different rendering units may be provided. In general, rendering unit 24 may perform a first set of rendering tasks for, e.g., UE 14, and UE 14 may complete the rendering process, which may include warping rendered viewport data to correspond to a current view of a user of UE 14. For example, UE 14 may send a predicted pose (position and orientation) of the user to rendering unit 24, and rendering unit 24 may render a viewport according to the predicted pose. However, if the actual pose is different than the predicted pose at the time video data is to be presented to a user of UE 14, UE 14 may warp the rendered data to represent the actual pose (e.g., if the user has suddenly changed movement direction or turned their head).

While only a single rendering unit is shown in the example of FIG. 1, in other examples, each of UEs 12, 14 may be associated with a corresponding rendering unit. Rendering unit 24 as shown in the example of FIG. 1 is included in AR AS 22, which may be an edge server at an edge of a communication network. However, in other examples, rendering unit 24 may be included in a local network of, e.g., UE 12 or UE 14. For example, rendering unit 24 may be included in a personal computer (PC), laptop, tablet, or cellular phone of a user, and UE 14 may correspond to a wireless display device, e.g., AR/VR/MR/XR glasses or head mounted display (HMD). Although two UEs are shown in the example of FIG. 1, in general, multi-participant AR calls are also possible.

UEs 12, 14, and AR AS 22 may communicate AR data using a network communication protocol, such as Real-time Transport Protocol (RTP), which is standardized in Request for Comment (RFC) 3550 by the Internet Engineering Task Force (IETF). These and other devices involved in RTP communications may also implement protocols related to RTP, such as RTP Control Protocol (RTCP), Real-time Streaming Protocol (RTSP), Session Initiation Protocol (SIP), and/or Session Description Protocol (SDP).

In general, an RTP session may be established as follows. UE 12, for example, may receive an RTSP describe request from, e.g., UE 14. The RTSP describe request may include data indicating what types of data are supported by UE 14. UE 12 may respond to UE 14 with data indicating media streams that can be sent to UE 14, along with a corresponding network location identifier, such as a uniform resource locator (URL) or uniform resource name (URN).

UE 12 may then receive an RTSP setup request from UE 14. The RTSP setup request may generally indicate how a media stream is to be transported. The RTSP setup request may contain the network location identifier for the requested media data and a transport specifier, such as local ports for receiving RTP data and control data (e.g., RTCP data) on UE 14. UE 12 may reply to the RTSP setup request with a confirmation and data representing ports of UE 12 by which the RTP data and control data will be sent. UE 12 may then receive an RTSP play request, to cause the media stream to be “played,” i.e., sent to UE 14. UE 12 may also receive an RTSP teardown request to end the streaming session, in response to which, UE 12 may stop sending media data to UE 14 for the corresponding session.

UE 14, likewise, may initiate a media stream by initially sending an RTSP describe request to UE 12. The RTSP describe request may indicate types of data supported by UE 14. UE 14 may then receive a reply from UE 12 specifying available media streams, that can be sent to UE 14, along with a corresponding network location identifier, such as a uniform resource locator (URL) or uniform resource name (URN).

UE 14 may then generate an RTSP setup request and send the RTSP setup request to UE 12. As noted above, the RTSP setup request may contain the network location identifier for the requested media data and a transport specifier, such as local ports for receiving RTP data and control data (e.g., RTCP data) on UE 14. In response, UE 14 may receive a confirmation from UE 12, including ports of UE 12 that UE 12 will use to send media data and control data.

After establishing a media streaming session (e.g., AR communication session 28) between UE 12 and UE 14, UE 12 exchanges media data (e.g., packets of media data) with UE 14 according to the media streaming session. UE 12 and UE 14 may exchange control data (e.g., RTCP data) indicating, for example, reception statistics by UE 14, such that UEs 12, 14 can perform congestion control or otherwise diagnose and address transmission faults.

UEs 12, 14 may be configured to perform any of the various techniques of this disclosure, e.g., relating to using a scene description including grouping data for multiple video textures (e.g., various video frames of various perspectives of stereo or multi-view video data) and/or a transform matrix for spatial audio data. Additionally, UEs 12, 14 may exchange scene descriptions and spatial media data. A receiver device (e.g., UE 14) may determine a position of a viewer in the virtual scene and present one or more of the texture frames to the viewer according to the position of the viewer in the virtual scene. The data grouping the spatially distinct data may include a layers property having one or more values representing a list of layer identifiers for layers of a track of media data that may be selected.

UEs 12, 14 may exchange AR media data related to a virtual scene, represented by the scene description. Users of UEs 12, 14 may view the virtual scene including virtual objects, as well as user AR data, such as avatars, shadows cast by the avatars, user virtual objects, user provided documents such as slides, images, videos, or the like, or other such data. Ultimately, users of UEs 12, 14 may experience an AR call from the perspective of their corresponding avatars (in first or third person) of virtual objects and avatars in the virtual scene. The AR media data described herein may correspond to spatial media data, that is, multi-channel media data, such as audio and/or video data. This spatial media data may include two or more channels including spatially distinct data for each presentation time instance. For example, the spatially distinct data may include two or more texture frames representing different perspectives of a common video presentation and/or two or more spatial audio frames representing different listener positions or sound generating objects. The scene description may include data grouping the spatially distinct data and data for characteristics of the spatially distinct data.

The various example components of FIG. 1 may perform various aspects of the techniques of this disclosure. This may facilitate precise synchronization and rendering of spatial (multi-channel) media data. Incorporating data grouping of spatially distinct data and characteristics directly into the scene description may enable MRF 26 to more efficiently signal relationships between multiple video textures and audio channels. This signaling may also allow receiving devices, such as UEs 12, 14, to perform reprojection and rendering processes using the signaled intrinsic and extrinsic parameters, thereby ensuring the generated view matches the user's position in the virtual scene.

Furthermore, utilizing a transform matrix for audio source placement may map graph nodes to specific speaker layers, which may allow UEs 12, 14 (or other receiving devices) to create a virtual acoustic environment that aligns with 3D visual content. These techniques may thereby support multi-view video textures and multi-channel audio, enhancing multimedia experiences by enabling the grouping and metadata description of multiple video textures for various multi-channel data types, such as stereo audio and/or video, as well as multi-view or other multi-perspective audio and/or video.

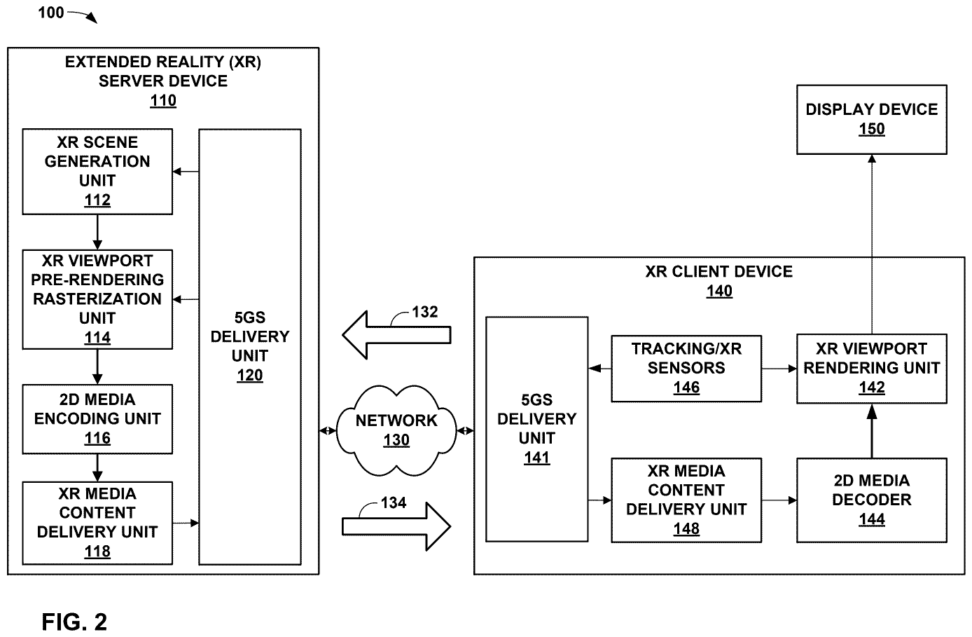

FIG. 2 is a block diagram illustrating an example computing system 100 that may perform split rendering techniques of this disclosure. In this example, computing system 100 includes extended reality (XR) server device 110, network 130, XR client device 140, and display device 150. XR server device 110 includes XR scene generation unit 112, XR viewport pre-rendering rasterization unit 114, 2D media encoding unit 116, XR media content delivery unit 118, and 5G System (5GS) delivery unit 120.

Network 130 may correspond to any network of computing devices that communicate according to one or more network protocols, such as the Internet. In particular, network 130 may include a 5G radio access network (RAN) including an access device to which XR client device 140 connects to access network 130 and XR server device 110. In other examples, other types of networks, such as other types of RANs, may be used. For example, network 130 may represent a wireless or wired local network. In other examples, XR client device 140 and XR server device 110 may communicate via other mechanisms, such as Bluetooth, a wired universal serial bus (USB) connection, or the like. XR client device 140 includes 5GS delivery unit 141, tracking/XR sensors 146, XR viewport rendering unit 142, 2D media decoder 144, and XR media content delivery unit 148. XR client device 140 also interfaces with display device 150 to present XR media data to a user (not shown).

In some examples, XR scene generation unit 112 may correspond to an interactive media entertainment application, such as a video game, which may be executed by one or more processors implemented in circuitry of XR server device 110. XR scene generation unit 112 may perform the steps of obtaining spatial media data including two or more channels including spatially distinct data for each presentation time instance. XR scene generation unit 112 may generate a scene description including data describing a virtual scene and a position at which the spatial media data is to be presented in the virtual scene. XR scene generation unit 112 may generate the scene description to include data grouping the spatially distinct data of the spatial media data and data for characteristics of the spatially distinct data.

For example, the data grouping the spatially distinct data may include a group identifier value, a group type value indicating whether the two or more channels are stereo channels or multi-perspective channels, and a mask value. The data for characteristics of the spatially distinct data may include intrinsic and extrinsic camera parameters. XR scene generation unit 112 may generate the scene description to include data representing a transform matrix that maps a graph node of an audio source to a speaker layout.

XR scene generation unit 112 may send the scene description and the spatial media data to a receiver device, such as XR client device 140, via XR media content delivery unit 118. XR viewport pre-rendering rasterization unit 114 may format scene data generated by XR scene generation unit 112 as pre-rendered two-dimensional (2D) media data (e.g., video data) for a viewport of a user of XR client device 140. 2D media encoding unit 116 may encode formatted scene data from XR viewport pre-rendering rasterization unit 114, e.g., using a video encoding standard, such as ITU-T H.264/Advanced Video Coding (AVC), ITU-T H.265/High Efficiency Video Coding (HEVC), ITU-T H.266 Versatile Video Coding (VVC), or the like. XR media content delivery unit 118 represents a content delivery sender, in this example. In this example, XR media content delivery unit 148 represents a content delivery receiver, and 2D media decoder 144 may perform error handling.

Consistent with the techniques of this disclosure, XR scene generation unit 112 may generate a scene description including data describing a virtual scene and a position at which spatial media data is to be presented in the virtual scene. This scene description may further include data grouping spatially distinct data of the spatial media data and data for characteristics of the spatially distinct data. For instance, XR scene generation unit 112 may format the scene description to include a group identifier value, a group type value indicating stereo or multi-view types, and a mask value for left/right eye presentation. XR scene generation unit 112 may also include intrinsic and extrinsic camera parameters in the scene description. Additionally, XR scene generation unit 112 may include a layers property in the grouping data, having values representing a list of layer identifiers for layers of a track of media data. XR scene generation unit 112 may further include data representing a transform matrix that maps a graph node of an audio source to a speaker layout to support multi-channel audio.

In general, XR client device 140 may determine a user's viewport, e.g., a direction in which a user is looking and a physical location of the user, which may correspond to an orientation of XR client device 140 and a geographic position of XR client device 140. Tracking/XR sensors 146 may determine such location and orientation data, e.g., using cameras, accelerometers, magnetometers, gyroscopes, or the like. Tracking/XR sensors 146 provide location and orientation data to XR viewport rendering unit 142 and 5GS delivery unit 141. XR client device 140 provides tracking and sensor information 132 to XR server device 110 via network 130. XR server device 110, in turn, receives tracking and sensor information 132 and provides this information to XR scene generation unit 112 and XR viewport pre-rendering rasterization unit 114. In this manner, XR scene generation unit 112 can generate scene data for the user's viewport and location, and then pre-render 2D media data for the user's viewport using XR viewport pre-rendering rasterization unit 114. XR server device 110 may therefore deliver encoded, pre-rendered 2D media data 134 to XR client device 140 via network 130, e.g., using a 5G radio configuration.

XR client device 140 may receive the scene description and the spatial media data via XR media content delivery unit 148. XR viewport rendering unit 142 may use the scene description to present one or more texture frames to the viewer according to the position of the viewer in the virtual scene. For example, XR viewport rendering unit 142 may perform disparity estimation, depth map refinement, 3D reconstruction, and reprojection using the intrinsic and extrinsic camera parameters signaled in the scene description. Furthermore, XR client device 140 may receive audio data and map the audio data to a position of a speaker in the virtual scene using the transform matrix included in the scene description.

XR scene generation unit 112 may receive data representing a type of multimedia application (e.g., a type of video game), a state of the application, multiple user actions, or the like. XR viewport pre-rendering rasterization unit 114 may format a rasterized video signal. 2D media encoding unit 116 may be configured with a particular encoder/decoder (codec), bitrate for media encoding, a rate control algorithm and corresponding parameters, data for forming slices of pictures of the video data, low latency encoding parameters, error resilience parameters, intra-prediction parameters, or the like. XR media content delivery unit 118 may be configured with real-time transport protocol (RTP) parameters, rate control parameters, error resilience information, and the like. XR media content delivery unit 148 may be configured with feedback parameters, error concealment algorithms and parameters, post correction algorithms and parameters, and the like.

Raster-based split rendering refers to the case where XR server device 110 runs an XR engine (e.g., XR scene generation unit 112) to generate an XR scene based on information coming from an XR device, e.g., XR client device 140 and tracking and sensor information 132. XR server device 110 may rasterize an XR viewport and perform XR pre-rendering using XR viewport pre-rendering rasterization unit 114.

In the example of FIG. 2, the viewport is predominantly rendered in XR server device 110, but XR client device 140 is able to do latest pose correction, for example, using asynchronous time warping or other XR pose correction to address changes in the pose. XR graphics workload may be split into rendering workload on a powerful XR server device 110 (in the cloud or the edge) and pose correction (such as asynchronous time warp (ATW)) on XR client device 140. Low motion-to-photon latency is preserved via on-device Asynchronous Time Warping (ATW) or other pose correction methods performed by XR client device 140.

The various components of XR server device 110, XR client device 140, and display device 150 may be implemented using one or more processors implemented in circuitry, such as one or more digital signal processors (DSPs), general purpose microprocessors, application specific integrated circuits (ASICs), field programmable logic arrays (FPGAs), or other equivalent integrated or discrete logic circuitry. The functions attributed to these various components may be implemented in hardware, software, or firmware. When implemented in software or firmware, it should be understood that instructions for the software or firmware may be stored on a computer-readable medium and executed by requisite hardware.

XR client device 140 may be configured to perform any of the various techniques of this disclosure related to using a scene description including grouping data for multiple video textures (e.g., various video frames of various perspectives of stereo or multi-view video data) and/or a transform matrix for spatial audio data.

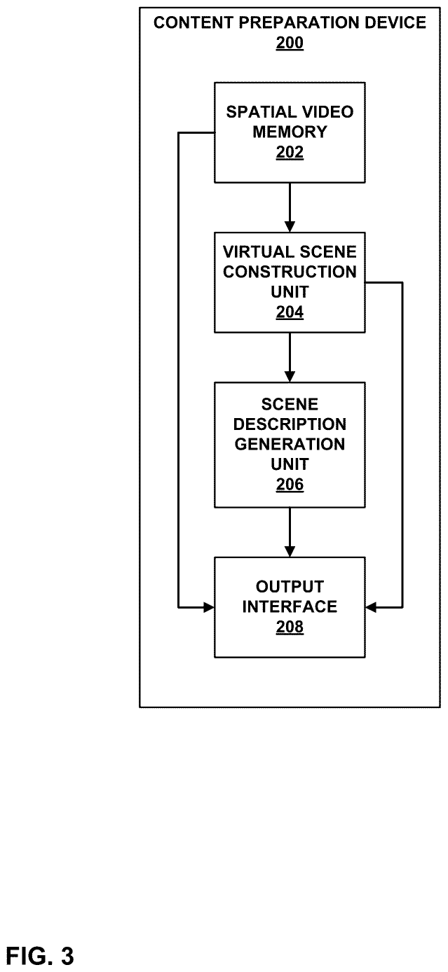

FIG. 3 is a block diagram illustrating an example content preparation device 200 according to techniques of this disclosure. In this example, content preparation device 200 includes spatial video memory 202, virtual scene construction unit 204, scene description generation unit 206, and output interface 208. Content preparation device 200 may be a user equipment (UE) device, and may correspond to one of UEs 12, 14 of FIG. 1 or XR client device 140 of FIG. 2.

Spatial video memory 202 stores spatial video data including two or more views of a scene, e.g., stereo view video data or multi-view video data. In particular, content preparation device 200 may obtain and store the spatial video data to spatial video memory 202. In some examples, content preparation device 200 may include one or more cameras (not shown) for capturing the spatial video. In some examples, content preparation device 200 includes a graphics processing unit (GPU, not shown) for generating and rendering the spatial video. In some examples, content preparation device 200 includes an interface for retrieving or receiving the spatial video data. Spatial video memory 202 may store spatial media data including two or more channels including spatially distinct data for each presentation time instance. The spatially distinct data for each presentation time instance may include two or more texture frames representing different perspectives of a common video presentation. Additionally or alternatively, the spatially distinct data for each presentation time instance may include two or more spatial audio frames representing different listener positions for a common audio presentation.

Virtual scene construction unit 204 is configured to construct a virtual scene. For example, virtual scene construction unit 204 may represent a unit configured to generate data representing a virtual scene including a position or surface of an “ideal position” for media data corresponding to a camera and/or microphone used to record media data of the media presentation.

Scene description generation unit 206 is configured to generate a scene description for the virtual scene. Per the techniques of this disclosure, the scene description includes data representing data for the spatial video, e.g., a group identifier value, a group type value, camera intrinsic and extrinsic parameters, and a mask indicating whether a corresponding video texture of the spatial video is intended to be presented to a viewer's left eye, right eye, or either/both eyes. Additionally, the scene description may include audio spatial data including a transform matrix, as discussed above.

Content preparation device 200 may obtain spatial video data and store the spatial video data in spatial video memory 202. The spatial video data includes two or more channels including spatially distinct data for each presentation time instance. For example, the spatial video data may include two or more frames for each frame output time instance (e.g., each frame number).

Scene description generation unit 206 may generate the scene description to include data grouping the spatially distinct data of the spatial video data and data for characteristics of the spatially distinct data. For example, the data grouping the spatially distinct data may include a group identifier value, a group type value indicating whether the two or more channels are stereo channels or multi-perspective channels, and a mask value indicating whether the corresponding spatial media data are to be presented to a left side, a right side, or both sides. The data for characteristics of the spatially distinct data may include intrinsic and extrinsic camera parameters. Scene description generation unit 206 may also generate the scene description to include data representing a transform matrix that maps a graph node of an audio source to a speaker layout. Content preparation device 200 may send the scene description and the spatial video data to a receiver device via output interface 208.

In this manner, scene description generation unit 206 may enable the creation of interoperable 3D scenes that support advanced immersive media, e.g., multi-channel video data. Through embedding data grouping spatially distinct data and specific characteristics, content preparation device 200 may ensure that the resulting scene description carries metadata that can be used to render media data, such as intrinsic and extrinsic camera parameters, for a position of a user in a virtual scene. This signaling structure may thereby allow compatible receivers to perform accurate disparity estimation and depth map generation and/or refinement. Legacy receivers may be configured to simply identify a primary channel and only present the data of the primary channel. Thus, the techniques of this disclosure may also be backwards compatible with receivers not configured to perform the techniques of this disclosure, while also enabling capable receivers to select appropriate channels to be used to render the media data based on a position of a user in a virtual environment.

Output interface 208 is generally configured to output each of AR media data, spatial video data, spatial audio data, and the scene description. For example, output interface 208 may correspond to a network interface card (NIC), e.g., a wired or wireless Ethernet card. Output interface 208 may alternatively correspond to a physical interface configured to store each of AR media data, spatial video data, spatial audio data, and the scene description to a computer-readable storage medium, such as a thumbdrive, a disk, or the like.

In this manner, content preparation device 200 represents an example of a device for communicating media data, including: a memory configured to store spatial media data; and a processing system implemented in circuitry and configured to: obtain the spatial media data, the spatial media data including two or more channels including spatially distinct data for each presentation time instance; generate a scene description including data describing a virtual scene and a position at which the spatial media data is to be presented in the virtual scene, the scene description further including data grouping the spatially distinct data of the spatial media data and data for characteristics of the spatially distinct data; and send the scene description and the spatial media data to a receiver device.

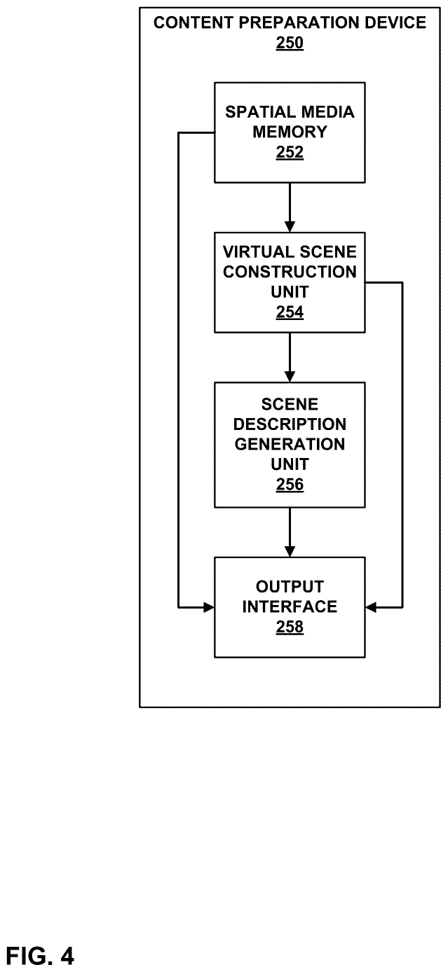

FIG. 4 is a block diagram illustrating an example content preparation device 250 that may perform techniques of this disclosure. In this example, content preparation device 250 includes spatial media memory 252, virtual scene construction unit 254, scene description generation unit 256, and output interface 258. Content preparation device 250 may be a user equipment (UE) device, and may correspond to one of UEs 12, 14 of FIG. 1 or XR client device 140 of FIG. 2.

Spatial media memory 252 stores spatial media data. This spatial media data may include multi-channel video data, such as stereo video or multi-view video, and/or multi-channel audio data, such as spatial audio or object-based audio with defined channel layouts (e.g., 5.1, 7.1, or the like). The spatial media data generally includes two or more channels having spatially distinct data for each presentation time instance. For video, the spatially distinct data corresponds to texture frames representing different perspectives (views). For audio, the spatially distinct data corresponds to audio frames representing different listener positions or spatial directions.

Virtual scene construction unit 254 constructs a virtual scene. Virtual scene construction unit 254 may allow a receiving device to import the spatial media data from spatial media memory 252 and place the spatial media data within a 3D environment. For example, virtual scene construction unit 254 may define a location for a virtual screen to display spatial video or a location for a virtual audio source, e.g., based on a position of a user of the receiving device.

Scene description generation unit 256 generates a scene description for the virtual scene constructed by virtual scene construction unit 254. Scene description generation unit 256 processes the spatial media data to generate metadata defining how the receiving device should render the multi-channel content.

Regarding multi-channel video processing, scene description generation unit 256 may generate data grouping two or more texture frames of the spatial video. This data may include a group identifier (group_id) associating the texture frames, a group type indicating whether the frames represent “stereo” or “multi-view” content, and a mask indicating a target eye (e.g., left eye, right eye, or both) for each texture frame. Scene description generation unit 256 may also insert data for characteristics of the spatially distinct video data, such as intrinsic camera parameters (e.g., a 3×3 matrix, focal length, principal point, skew factor) and extrinsic camera parameters (e.g., translation, rotation). This metadata may enable a receiving device to perform disparity estimation and reprojection, which may allow the receiving device to generate novel views of the video presentation, based on a position of the user of the receiving device in the virtual scene.

Regarding multi-channel audio processing, scene description generation unit 256 may generate data to support spatial audio rendering. Scene description generation unit 256 may define an audio source type as “channels” within the scene description. To spatially locate these channels within the 3D scene, scene description generation unit 256 generates and inserts a transform matrix (T_{mapping}). This transform matrix maps a graph node of the audio source to a specific speaker layer or layout in the virtual scene. For example, scene description generation unit 256 may configure the scene description such that a receiving device calculates a position of a specific virtual speaker (T_{speaker_i}) by applying the transform matrix to the source node position (T_{source_node}), potentially modified by a channel mask (Mᵢ).

Output interface 258 outputs the generated scene description and the spatial media data (audio and/or video). Output interface 258 may transmit these data structures to a receiving device via a network or store the data structures to a storage medium.

The configuration of content preparation device 250 may unify the description of spatial audio and video within a standardized scene description format. By employing scene description generation unit 256 to calculate and insert a transform matrix for audio sources, content preparation device 250 allows for the virtualization of complex speaker layouts (e.g., 7.1 surround sound) within a 3D AR/VR/MR/XR scene without requiring physical speaker setups. This may transform the audio source graph node into a spatially aware audio object. Simultaneously, by grouping video textures and providing intrinsic/extrinsic camera parameters, content preparation device 250 may enable precise depth rendering and view synthesis for video. This dual capability ensures that the sensory experience (both visual and auditory) of the user remains spatially coherent as the user navigates the virtual scene, thereby addressing the challenge of synchronizing multi-modal spatial media in legacy scene description formats.

In this manner, content preparation device 250 represents an example of a device for communicating media data, including: a memory configured to store spatial media data; and a processing system implemented in circuitry and configured to: obtain the spatial media data, the spatial media data including two or more channels including spatially distinct data for each presentation time instance; generate a scene description including data describing a virtual scene and a position at which the spatial media data is to be presented in the virtual scene, the scene description further including data grouping the spatially distinct data of the spatial media data and data for characteristics of the spatially distinct data; and send the scene description and the spatial media data to a receiver device.

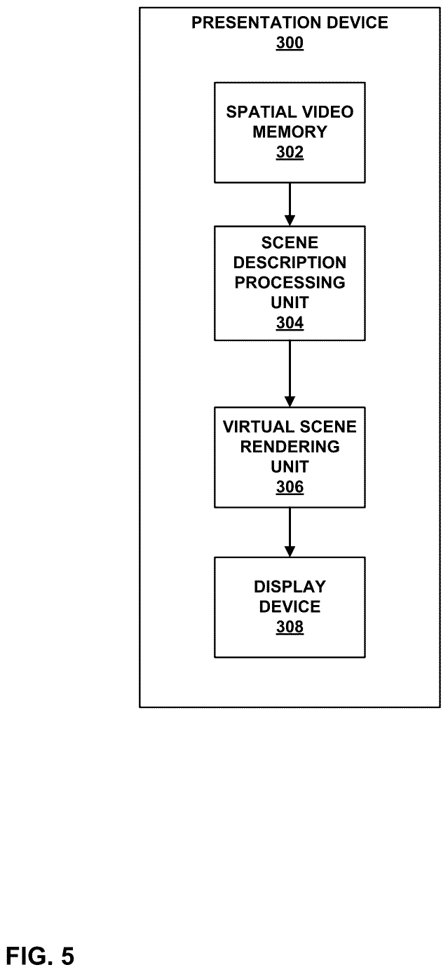

FIG. 5 is a block diagram illustrating an example presentation device 300 that may perform techniques of this disclosure. In this example, presentation device 300 includes spatial video memory 302, scene description processing unit 304, virtual scene rendering unit 306, and display device 308. Presentation device 300 may be a user equipment (UE) device, and may correspond to one of UEs 12, 14 of FIG. 1 or XR client device 140 of FIG. 2. A single UE device or other device may include components of both content preparation device 200 and presentation device 300 in some examples.

Spatial video memory 302 stores spatial video data including two or more views of a scene, e.g., stereo view video data or multi-view video data. Presentation device 300 may receive the spatial video data as part of an AR session, e.g., from a corresponding content preparation device, which may be another UE device. Spatial video memory 302 may generally store spatial media data including two or more channels including spatially distinct data for each presentation time instance. The spatially distinct data may include two or more texture frames representing different perspectives of a common video presentation.

Scene description processing unit 304 is configured to process a scene description per the techniques of this disclosure. For example, scene description processing unit 304 may determine which sets of video data correspond to a common group using a group identifier, whether the group is a stereo video group or a multi-view video type, camera intrinsic and/or extrinsic parameters, and a mask indicating whether the corresponding video texture is to be presented to a viewer's left eye, right eye, or either/both eyes. Scene description processing unit 304 may parse the scene description to obtain data grouping the spatially distinct data of the spatial media data and data for characteristics of the spatially distinct data.

The data grouping the spatially distinct data may include a group identifier value, a group type value indicating whether the two or more channels are stereo channels or multi-perspective channels, and a mask value. The data grouping may also include a layers property having one or more values representing a list of layer identifiers for layers of a track of media data that may be selected. The data for characteristics of the spatially distinct data may include intrinsic camera parameters (e.g., a 3×3 matrix, focal length, principal point, skew factor) and extrinsic camera parameters (e.g., translation, rotation).

Virtual scene rendering unit 306 may then render a virtual scene using data from the scene description, as well as a position of a user of presentation device 300 (also referred to as a “viewer”) in a virtual environment. Virtual scene rendering unit 306 may generally render the virtual scene to include virtual objects, as well as stereo video at a position indicated by the scene description. Virtual scene rendering unit 306 may select from among the various video textures to use to re-render the video data of the spatial video according to a position of the viewer in the virtual scene. Ultimately, virtual scene rendering unit 306 may render a left eye view and a right eye view per the techniques of this disclosure. Virtual scene rendering unit 306 may determine a position of a user in the virtual scene and present one or more of the spatially distinct data to the user according to the position of the user in the virtual scene.

To present the spatially distinct data (e.g., texture frames), virtual scene rendering unit 306 may perform disparity estimation using the two or more texture frames to determine disparity information. Virtual scene rendering unit 306 may perform depth map refinement using the disparity information to generate a depth map. Virtual scene rendering unit 306 may perform a three-dimensional reconstruction process to generate three-dimensional objects of the two or more texture frames. Virtual scene rendering unit 306 may reproject the three-dimensional objects to generate two or more views of the three-dimensional objects to be presented to the user. Virtual scene rendering unit 306 may use the position of the user and the extrinsic/intrinsic camera parameters signaled in the scene description to perform these rendering operations.

Presentation device 300 may therefore allow for the accurate reconstruction and rendering of immersive multi-channel media data based on a position of a user of presentation device 300 in a virtual scene. Scene description processing unit 304 may extract the grouping data and characteristics such as intrinsic and extrinsic camera parameters, which may thereby enable virtual scene rendering unit 306 to perform advanced view synthesis techniques like disparity estimation and reprojection. This capability may allow virtual scene rendering unit 306 to render flat or static textures in a 3D environment, thus enabling presentation device 300 to present a stereoscopic or multi-view experience that dynamically adapts to the position of the user within the virtual scene. Ultimately, a rendered scene may be presented via display device 308 to the user, which may be a screen, multiple screens, a head mounted display (HMD), or the like.

In this manner, presentation device 300 represents an example of a device for communicating media data, including: a memory configured to store spatial media data; and a processing system implemented in circuitry and configured to: receive the spatial media data, the spatial media data including two or more channels including spatially distinct data for each presentation time instance; receive a scene description including data describing a virtual scene and a position at which the spatial media data is to be presented in the virtual scene, the scene description further including data grouping the spatially distinct data of the spatial media data and data for characteristics of the spatially distinct data; determine a position of a user in the virtual scene; and present one or more of the spatially distinct data to the user according to the position of the user in the virtual scene.

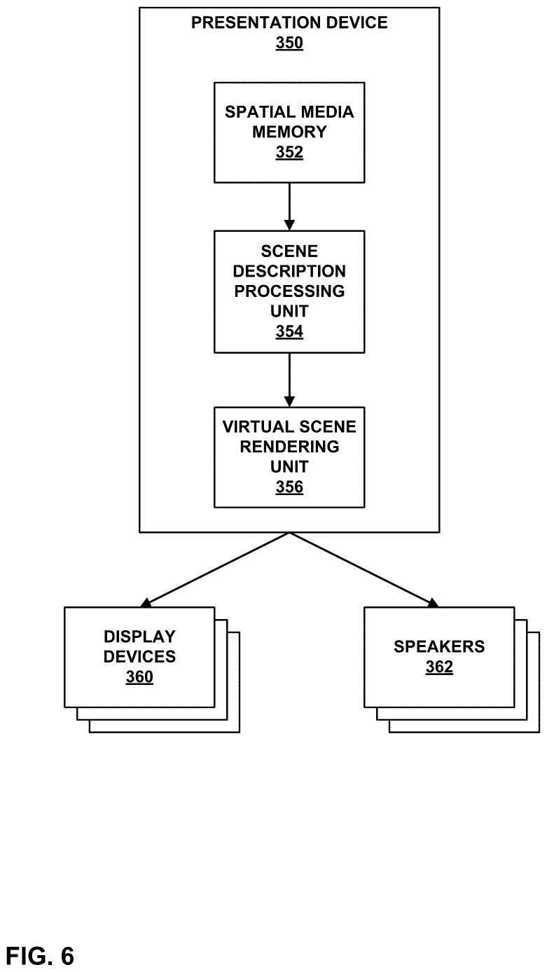

FIG. 6 is a block diagram illustrating an example presentation device 350 that may perform techniques of this disclosure. In this example, presentation device 350 includes spatial media memory 352, scene description processing unit 354, virtual scene rendering unit 356, display devices 360, and speakers 362. Presentation device 350 may be a user equipment (UE) device, and may correspond to one of UEs 12, 14 of FIG. 1 or XR client device 140 of FIG. 2.

Spatial media memory 352 stores spatial media data including two or more channels having spatially distinct data for each presentation time instance. This spatial media data may include multi-channel video data (e.g., stereo or multi-view video textures) and/or multi-channel audio data (e.g., spatial audio streams). In particular, presentation device 300 may receive the spatial media data via a media communication session with one or more other participants.

Scene description processing unit 354 processes a scene description received via the media communication session and extracts metadata from the scene description that may be used to control the presentation of the spatial media data. Scene description processing unit 354 parses the scene description to obtain data grouping the spatially distinct data and data for characteristics of the spatially distinct data. For video, scene description processing unit 354 extracts grouping identifiers, group types (e.g., “stereo” or “multi-view”), masks identifying target eyes (e.g., left, right, or both), and camera parameters (intrinsic and extrinsic). For audio data, scene description processing unit 354 may extract a transform matrix (T_{mapping}) associated with an audio source graph node.

Virtual scene rendering unit 356 renders the virtual scene for presentation to a user. Virtual scene rendering unit 356 determines a position and orientation of the user within the virtual scene. Virtual scene rendering unit 356 then uses the position and orientation of the user in the virtual scene and the metadata extracted by scene description processing unit 354 to render the spatial media data.

In particular, for video presentation, virtual scene rendering unit 356 may select appropriate texture frames from spatial media memory 352 based on the grouping and mask data and the position and orientation of the user. Virtual scene rendering unit 356 may use the intrinsic and extrinsic camera parameters to perform operations such as disparity estimation, depth map refinement, 3D reconstruction, and reprojection. Virtual scene rendering unit 356 may generate viewports that match the perspective of the user in the virtual scene and outputs these viewports to display devices 360. Display devices 360 may include multi-view screens, XR head mounted display (HMD) devices, or multiple XR HMD devices. For example, virtual scene rendering unit 356 may direct a reprojected left-eye view to a left display of an HMD and a reprojected right-eye view to a right display of the HMD.

Regarding audio presentation, virtual scene rendering unit 356 may use the transform matrix extracted from the scene description to spatially map audio channels to the virtual environment. Virtual scene rendering unit 356 may calculate virtual speaker positions (T_{speaker_i}) by applying the transform matrix to the audio source node (T_{source_node}). Virtual scene rendering unit 356 may render the audio data such that the sound appears to originate from these virtual positions relative to the position and orientation of the user in the virtual scene. Virtual scene rendering unit 356 outputs the rendered audio signals to speakers 362. Speakers 362 may include a speaker array, left/right ear speakers, headphones, HMD speakers, surround sound speakers (3.1, 5.1, 7.1), or the like.

By using scene description processing unit 354 to extract the transform matrix and grouping metadata, presentation device 350 may dynamically map abstract multi-channel content to specific physical hardware configurations (speakers 362) and reproject video data based on a position and orientation of a user in a virtual scene. These capabilities allow presentation device 350 to maintain spatial coherence between the visual and auditory components of the scene as the user moves through the virtual scene, thereby allowing for dynamic rendering of static multi-channel media in a dynamic SixDegrees of Freedom (6DoF) environment.

In this manner, presentation device 350 represents an example of a device for communicating media data, including: a memory configured to store spatial media data; and a processing system implemented in circuitry and configured to: receive the spatial media data, the spatial media data including two or more channels including spatially distinct data for each presentation time instance; receive a scene description including data describing a virtual scene and a position at which the spatial media data is to be presented in the virtual scene, the scene description further including data grouping the spatially distinct data of the spatial media data and data for characteristics of the spatially distinct data; determine a position of a user in the virtual scene; and present one or more of the spatially distinct data to the user according to the position of the user in the virtual scene.

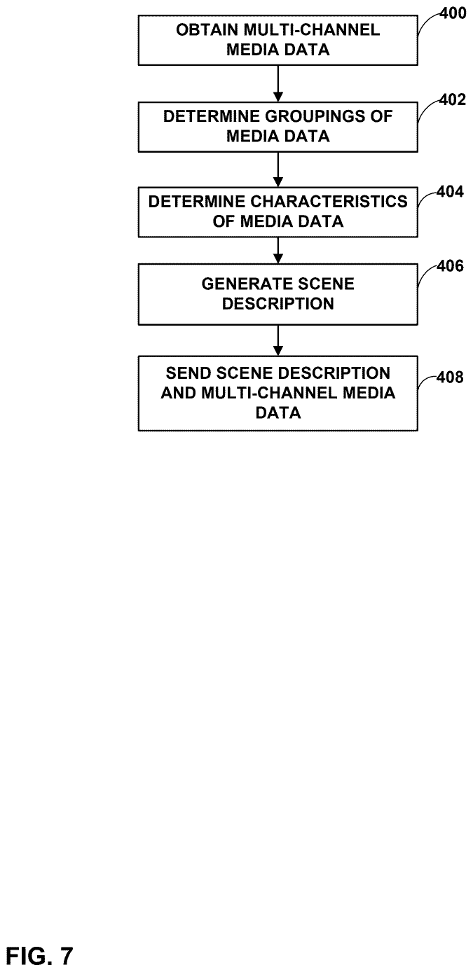

FIG. 7 is a flowchart illustrating an example method of preparing and sending a scene description for multi-channel media data to a receiving device according to techniques of this disclosure. For purposes of example, the method of FIG. 7 is described with respect to content preparation device 250 of FIG. 4. However, other devices, such as UEs 12, 14 of FIG. 1, XR client device 140 of FIG. 2, or content preparation device 200 of FIG. 3, may perform this or a similar method.

Initially, content preparation device 250 obtains spatial media data including two or more channels including spatially distinct data for each presentation time instance (400). Obtaining the spatial media data may include any or all of capturing the spatial media data using one or more cameras, generating the spatial media data using a graphics processing unit (GPU), or retrieving the spatial media data from a memory or other interface to a media data providing device. The spatially distinct data for each presentation time instance may include two or more texture frames representing different perspectives of a common video presentation. Additionally or alternatively, the spatially distinct data for each presentation time instance may include two or more spatial audio frames representing different listener positions for a common audio presentation.

Content preparation device 250 may then determine groupings of the media data (402). Content preparation device 250 may generate data that groups the spatially distinct data of the spatial media data into respective groups. This data grouping the spatially distinct data may include one or more of a group identifier value that indicates the two or more channels that are associated in a group, a group type value indicating whether the two or more channels are stereo channels or multi-perspective channels, and a mask value indicating whether the corresponding spatial media data are to be presented to a left side, a right side, or either side of a user. The data grouping the spatially distinct data may also include a layers property having one or more values representing a list of layer identifiers for layers of a track of media data that may be selected.

Content preparation device 250 may also determine characteristics of the media data (404). For example, for video data, the data for the characteristics of the spatially distinct data may include data for characteristics of the two or more texture frames, including one or more of intrinsic camera parameters including a 3×3 matrix, focal length, principal point, and skew factor, and/or extrinsic camera parameters representing translation or rotation.

Content preparation device 250 generates a scene description (406). Content preparation device 250 generates the scene description including data describing a virtual scene and a position at which the spatial media data is to be presented in the virtual scene. Content preparation device 250 includes the data grouping the spatially distinct data and the data for characteristics of the spatially distinct data in the scene description. Content preparation device 250 may generate the scene description to include data representing a transform matrix that maps a graph node of an audio source to a speaker layout.

Content preparation device 250 then sends the scene description and the multi-channel media data to a receiving device (408). Content preparation device 250 may send the scene description and the spatial media data to the receiver device via output interface 258.

In this manner, the method of FIG. 7 represents an example of a method of communicating media data, including: obtaining spatial media data including two or more channels including spatially distinct data for each presentation time instance; generating a scene description including data describing a virtual scene and a position at which the spatial media data is to be presented in the virtual scene, the scene description further including data grouping the spatially distinct data of the spatial media data and data for characteristics of the spatially distinct data; and sending the scene description and the spatial media data to a receiver device.

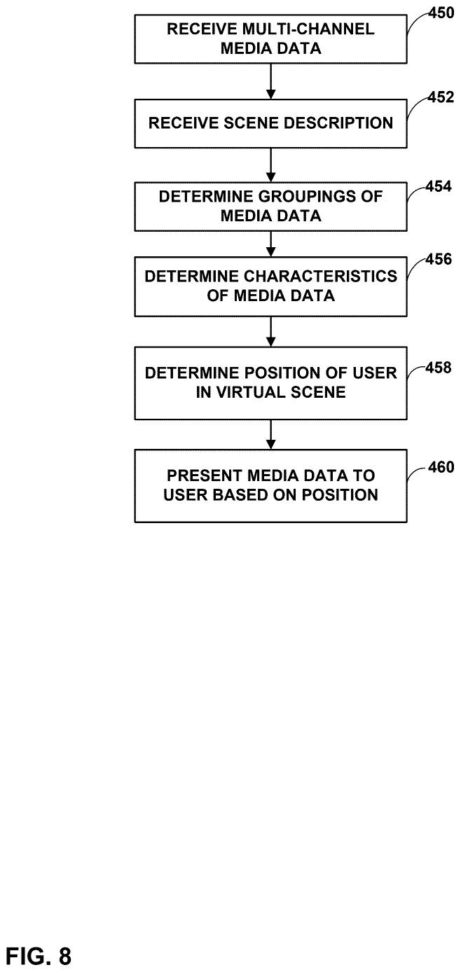

FIG. 8 is a flowchart illustrating an example method of receiving multi-channel media data and a scene description for the multi-channel media data and rendering output media data based on a position of a user in a virtual scene according to techniques of this disclosure. For purposes of example, the method of FIG. 8 is described with respect to presentation device 350. However, other devices, such as UEs 12, 14 of FIG. 1, XR client device 140 of FIG. 2, or presentation device 300 of FIG. 5 may be configured to perform this or a similar method.

Presentation device 350 initially receives spatial media data including two or more channels including spatially distinct data for each presentation time instance (450). Presentation device 350 may store the spatial media data in spatial media memory 352. The spatially distinct data for each presentation time instance may include two or more texture frames representing different perspectives of a common video presentation. Additionally or alternatively, the spatially distinct data for each presentation time instance may include two or more spatial audio frames representing different listener positions for a common audio presentation.

Presentation device 350 then receives a scene description (452). Scene description processing unit 354 may receive the scene description and extract data describing a virtual scene and a position at which the spatial media data is to be presented in the virtual scene. Scene description processing unit 354 may also extract data grouping the spatially distinct data of the spatial media data and data for characteristics of the spatially distinct data.

Scene description processing unit 354 may determine groupings of the media data from the scene description (454). The grouping data may include a group identifier value that indicates the two or more texture frames that are associated in a group, a group type value indicating whether the two or more texture frames are stereo video or multi-view video, and a mask value indicating whether the corresponding texture frames are to be presented to a left eye, a right eye, or either eye of the user. The data grouping may also include a layers property having one or more values representing a list of layer identifiers for layers of a track of media data that may be selected.

Presentation device 350 may further determine characteristics of the media data (456). Scene description processing unit 354 may parse the scene description to determine the data for the characteristics of the spatially distinct data. For video, this data may include characteristics of two or more texture frames, including one or more of intrinsic camera parameters including a 3×3 matrix, focal length, principal point, and skew factor, and/or extrinsic camera parameters representing translation or rotation. For audio, scene description processing unit 354 may identify data representing a transform matrix that maps a graph node of an audio source to a speaker layout.

Presentation device 350 may then determine a position of a user in the virtual scene (458). Virtual scene rendering unit 356 may determine the position of the user based on input from tracking sensors associated with the user, such as gyroscopes, accelerometers, or the like, and/or based on input received from the user, e.g., via controllers or hand tracking input.

Presentation device 350 presents the media data to the user based on the position of the user in the virtual scene (460). Virtual scene rendering unit 356 presents one or more of the spatially distinct data to the user according to the position of the user in the virtual scene. When the spatially distinct data includes two or more texture frames, virtual scene rendering unit 356 may perform disparity estimation using the two or more texture frames to determine disparity information for the two or more texture frames. Virtual scene rendering unit 356 may perform depth map refinement using the disparity information to generate a depth map for the two or more texture frames. Virtual scene rendering unit 356 may perform a three-dimensional reconstruction process to generate three-dimensional objects of the two or more texture frames. Virtual scene rendering unit 356 may perform reprojection of the three-dimensional objects to generate two or more views of the three-dimensional objects to be presented to the user. Virtual scene rendering unit 356 may perform the disparity estimation, depth map refinement, three-dimensional reconstruction process, and reprojection using the position of the user and using extrinsic and intrinsic camera parameters signaled in the scene description.

When the spatially distinct data includes two or more spatial audio frames, virtual scene rendering unit 356 may map the two or more spatial audio frames to a position of a speaker in the virtual scene using the transform matrix. For example, virtual scene rendering unit 356 may calculate the position of the speaker (T_{speaker_i}) using the graph node (T_{source_node}), the transform matrix (T_{mapping}), and a mask (Mᵢ) for masking the audio to a left ear or a right ear of the user, according to the equation T_{speaker_i}=T_{source_node}*T_{mapping}*Mi. Alternatively, virtual scene rendering unit 356 may calculate the position of the speaker without the mask according to the equation T_{speaker_i}=T_{source_node}*T_{mapping}.

In some examples, a receiving device may not support full spatial rendering. In such cases, the receiving device may determine a primary channel of the two or more channels and present only the spatially distinct data of the primary channel.

In this manner, the method of FIG. 8 represents an example of a method of communicating media data, including: receiving spatial media data including two or more channels including spatially distinct data for each presentation time instance; receiving a scene description including data describing a virtual scene and a position at which the spatial media data is to be presented in the virtual scene, the scene description further including data grouping the spatially distinct data of the spatial media data and data for characteristics of the spatially distinct data; determining a position of a user in the virtual scene; and presenting one or more of the spatially distinct data to the user according to the position of the user in the virtual scene.

Various examples of the techniques of this disclosure are summarized in the following clauses:

Clause 1: A method of communicating media data, the method comprising: obtaining a spatial video including two or more texture frames for each presentation time instance, the two or more texture frames representing different perspectives of a common video presentation; generating a scene description including data describing a virtual scene and a position at which the spatial video is to be presented in the virtual scene, the scene description further including data grouping the two or more texture frames of the spatial video and characteristics for the two or more texture frames; and sending the scene description and the spatial video to a receiver device.

Clause 2: The method of clause 1, further comprising generating the scene description to include data representing a transform matrix that maps a graph node of an audio source to a speaker layout.

Clause 3: The method of any of clauses 1 and 2, wherein obtaining the spatial video comprises capturing the spatial video using one or more cameras.

Clause 4: The method of any of clauses 1 and 2, wherein obtaining the spatial video comprises generating the spatial video.

Clause 5: The method of any of clauses 1 and 2, wherein obtaining the spatial video comprises retrieving the spatial video.

Clause 6: A method of communicating media data, the method comprising: receiving a spatial video including two or more texture frames for each presentation time instance, the two or more texture frames representing different perspectives of a common video presentation; receiving a scene description including data describing a virtual scene and a position at which the spatial video is to be presented in the virtual scene, the scene description further including data grouping the two or more texture frames of the spatial video and characteristics for the two or more texture frames; determining a position of a viewer in the virtual scene; and presenting one or more of the texture frames to the viewer according to the position of the viewer in the virtual scene.

Clause 7: The method of clause 6, wherein the scene description further includes data representing a transform matrix that maps a graph node of an audio source to a speaker layout, the method further comprising: receiving audio data for the audio source; and mapping the audio data to a position of a speaker in the virtual scene using the transform matrix.

Clause 8: The method of clause 7, wherein the transform matrix comprises T_{mapping}, the speaker comprises T_{speaker_i}, the graph node comprises T_{source_node}, Mᵢ comprises a mask for masking the audio to a viewer's left ear or the viewer's right ear, and wherein mapping the audio data comprises calculating T_{speaker_i}=T_{source_node}*T_{mapping}*Mᵢ.

Clause 9: The method of clause 7, wherein the transform matrix comprises T_{mapping}, the speaker comprises T_{speaker_i}, the graph node comprises T_{source_node}, and wherein mapping the audio data comprises calculating T_{speaker_i}=T_{source_node}*T_{mapping}.

Clause 10: The method of any of clauses 6-9, wherein presenting the one or more of the texture frames comprises: performing disparity estimation using the one or more of the texture frames to determine disparity information for the one or more of the texture frames; performing depth map refinement using the disparity information to generate a depth map for the one or more texture frames; performing a three-dimensional reconstruction process to generate three-dimensional objects of the one or more texture frames; and performing reprojection of the three-dimensional objects to generate two or more views of the three-dimensional objects to be presented to the viewer.

Clause 11: The method of clause 10, wherein performing disparity estimation, performing depth map refinement, performing the three-dimensional reconstruction process, and performing reprojection includes using the position of the viewer.

Clause 12: The method of any of clauses 10 and 11, wherein performing disparity estimation, performing depth map refinement, performing the three-dimensional reconstruction process, and performing reprojection includes using extrinsic and intrinsic camera parameters signaled in the scene description.

Clause 13: The method of any of clauses 1-12, wherein the data grouping the two or more texture frames of the spatial video includes one or more of a group identifier value that indicates the two or more texture frames that are associated in a group, a group type value indicating whether the two or more texture frames are stereo video or multi-view video, and a mask value indicating whether the corresponding texture frames are to be presented to a left eye, a right eye, or either eye of the viewer.

Clause 14: The method of any of clauses 1-13, wherein the data for the characteristics for the two or more texture frames includes one or more of intrinsic camera parameters including a 3×3 matrix, focal length, principal point, and skew factor or extrinsic camera parameters representing translation or rotation.

Clause 15: A device for communicating media data, the device comprising one or more means for performing the method of any of clauses 1-14.

Clause 16: The device of clause 15, wherein the one or more means comprise a processing system comprising one or more processors implemented in circuitry, and a memory configured to store AR media data.

Clause 17: A device for communicating media data, the device comprising: means for obtaining a spatial video including two or more texture frames for each presentation time instance, the two or more texture frames representing different perspectives of a common video presentation; means for generating a scene description including data describing a virtual scene and a position at which the spatial video is to be presented in the virtual scene, the scene description further including data grouping the two or more texture frames of the spatial video and characteristics for the two or more texture frames; and means for sending the scene description and the spatial video to a receiver device.

Clause 18: A device for communicating media data, the device comprising: means for receiving a spatial video including two or more texture frames for each presentation time instance, the two or more texture frames representing different perspectives of a common video presentation; means for receiving a scene description including data describing a virtual scene and a position at which the spatial video is to be presented in the virtual scene, the scene description further including data grouping the two or more texture frames of the spatial video and characteristics for the two or more texture frames; means for determining a position of a viewer in the virtual scene; and means for presenting one or more of the texture frames to the viewer according to the position of the viewer in the virtual scene.

Clause 19. A method of communicating media data, the method comprising: obtaining spatial media data including two or more channels including spatially distinct data for each presentation time instance; generating a scene description including data describing a virtual scene and a position at which the spatial media data is to be presented in the virtual scene, the scene description further including data grouping the spatially distinct data of the spatial media data and data for characteristics of the spatially distinct data; and sending the scene description and the spatial media data to a receiver device.

Clause 20. The method of clause 19, wherein the spatially distinct data for each presentation time instance includes two or more texture frames representing different perspectives of a common video presentation.

Clause 21. The method of clause 20, wherein the data for the characteristics of the spatially distinct data comprises data for characteristics of the two or more texture frames, including one or more of intrinsic camera parameters including a 3×3 matrix, focal length, principal point, and skew factor or extrinsic camera parameters representing translation or rotation.

Clause 22. The method of any of clauses 19-21, wherein the spatially distinct data for each presentation time instance includes two or more spatial audio frames representing different listener positions for a common audio presentation.

Clause 23. The method of any of clauses 19-22, further comprising generating the scene description to include data representing a transform matrix that maps a graph node of an audio source to a speaker layout.

Clause 24. The method of any of clauses 19-23, wherein obtaining the spatial media data comprises capturing the spatial media data.

Clause 25. The method of any of clauses 19-23, wherein obtaining the spatial media data comprises generating the spatial media data.

Clause 26. The method of any of clauses 19-23, wherein obtaining the spatial media data comprises retrieving the spatial media data.

Clause 27. The method of any of clauses 19-26, wherein the data grouping the spatially distinct data of the spatial media data includes one or more of a group identifier value that indicates the two or more channels that are associated in a group, a group type value indicating whether the two or more channels are stereo channels or multi-perspective channels, and a mask value indicating whether the corresponding spatial media data are to be presented to a left side, a right side, or either side of a user.

Clause 28. The method of any of clauses 19-27, wherein the data grouping the spatially distinct data includes a layers property having one or more values representing a list of layer identifiers for layers of a track of media data that may be selected.

Clause 29. A device for communicating media data, the device comprising: a memory configured to store spatial media data; and a processing system implemented in circuitry and configured to: obtain the spatial media data, the spatial media data including two or more channels including spatially distinct data for each presentation time instance; generate a scene description including data describing a virtual scene and a position at which the spatial media data is to be presented in the virtual scene, the scene description further including data grouping the spatially distinct data of the spatial media data and data for characteristics of the spatially distinct data; and send the scene description and the spatial media data to a receiver device.

Clause 30. The device of clause 29, wherein the data grouping the spatially distinct data of the spatial media data includes one or more of a group identifier value that indicates the two or more channels that are associated in a group, a group type value indicating whether the two or more channels are stereo channels or multi-perspective channels, and a mask value indicating whether the corresponding spatial media data are to be presented to a left side, a right side, or either side of a user.

Clause 31. The device of any of clauses 29 and 30, wherein the data grouping the spatially distinct data includes a layers property having one or more values representing a list of layer identifiers for layers of a track of media data that may be selected.

Clause 32. The device of any of clauses 29-31, wherein the spatially distinct data for each presentation time instance includes two or more texture frames representing different perspectives of a common video presentation, and wherein the data for the characteristics of the spatially distinct data comprises data for characteristics of the two or more texture frames, including one or more of intrinsic camera parameters including a 3×3 matrix, focal length, principal point, and skew factor or extrinsic camera parameters representing translation or rotation.

Clause 33. A method of communicating media data, the method comprising: receiving spatial media data including two or more channels including spatially distinct data for each presentation time instance; receiving a scene description including data describing a virtual scene and a position at which the spatial media data is to be presented in the virtual scene, the scene description further including data grouping the spatially distinct data of the spatial media data and data for characteristics of the spatially distinct data; determining a position of a user in the virtual scene; and presenting one or more of the spatially distinct data to the user according to the position of the user in the virtual scene.

Clause 34. The method of clause 33, wherein the spatially distinct data for each presentation time instance includes two or more texture frames representing different perspectives of a common video presentation.

Clause 35. The method of clause 34, wherein presenting the one or more of the spatially distinct data comprises: performing disparity estimation using the two or more texture frames to determine disparity information for the two or more texture frames; performing depth map refinement using the disparity information to generate a depth map for the two or more texture frames; performing a three-dimensional reconstruction process to generate three-dimensional objects of the two or more texture frames; and performing reprojection of the three-dimensional objects to generate two or more views of the three-dimensional objects to be presented to the user.

Clause 36. The method of clause 35, wherein performing disparity estimation, performing depth map refinement, performing the three-dimensional reconstruction process, and performing reprojection includes using the position of the user.

Clause 37. The method of any of clauses 35 and 36, wherein performing disparity estimation, performing depth map refinement, performing the three-dimensional reconstruction process, and performing reprojection includes using extrinsic and intrinsic camera parameters signaled in the scene description.

Clause 38. The method of any of clauses 34-37, wherein the data for the characteristics of the spatially distinct data comprises data for characteristics of the two or more texture frames, including one or more of intrinsic camera parameters including a 3×3 matrix, focal length, principal point, and skew factor or extrinsic camera parameters representing translation or rotation.

Clause 39. The method of any of clauses 34-38, wherein the data grouping the spatially distinct data comprises data grouping the two or more texture frames, including one or more of a group identifier value that indicates the two or more texture frames that are associated in a group, a group type value indicating whether the two or more texture frames are stereo video or multi-view video, and a mask value indicating whether the corresponding texture frames are to be presented to a left eye, a right eye, or either eye of the user.

Clause 40. The method of any of clauses 34-39, wherein the data grouping the spatially distinct data comprises data grouping the two or more texture frames, including a layers property having one or more values representing a list of layer identifiers for layers of a track of media data that may be selected.

Clause 41. The method of any of clauses 33-40, wherein the spatially distinct data for each presentation time instance includes two or more spatial audio frames representing different listener positions for a common audio presentation.

Clause 42. The method of clause 41, wherein the scene description further includes data representing a transform matrix that maps a graph node of an audio source to a speaker layout, the method further comprising mapping the two or more spatial audio frames to a position of a speaker in the virtual scene using the transform matrix.

Clause 43. The method of clause 42, wherein the transform matrix comprises Tmapping, the speaker comprises Tspeaker_i, the graph node comprises Tsource_node, Mi comprises a mask for masking the two or more spatial audio frames to a left ear or a right ear of the user, and wherein mapping the two or more spatial audio frames comprises calculating Tspeaker_i=Tsource_node*Tmapping*Mi.

Clause 44. The method of clause 42, wherein the transform matrix comprises Tmapping, the speaker comprises Tspeaker_i, the graph node comprises Tsource_node, and wherein mapping the two or more spatial audio frames comprises calculating Tspeaker_i=Tsource_node*Tmapping.

Clause 45. The method of clause 33, wherein presenting the one or more of the spatially distinct data comprises: determining a primary channel of the two or more channels; and presenting only the spatially distinct data of the primary channel.

Clause 46. A device for communicating media data, the device comprising: a memory configured to store spatial media data; and a processing system implemented in circuitry and configured to: receive the spatial media data, the spatial media data including two or more channels including spatially distinct data for each presentation time instance; receive a scene description including data describing a virtual scene and a position at which the spatial media data is to be presented in the virtual scene, the scene description further including data grouping the spatially distinct data of the spatial media data and data for characteristics of the spatially distinct data; determine a position of a user in the virtual scene; and present one or more of the spatially distinct data to the user according to the position of the user in the virtual scene.

Clause 47. The device of clause 46, wherein the data grouping the spatially distinct data of the spatial media data includes one or more of a group identifier value that indicates the two or more channels that are associated in a group, a group type value indicating whether the two or more channels are stereo channels or multi-perspective channels, and a mask value indicating whether the corresponding spatial media data are to be presented to a left side, a right side, or either side of the user.

Clause 48. The device of any of clauses 46 and 47, wherein the data grouping the spatially distinct data comprises data grouping the two or more channels of the spatial media data, including a layers property having one or more values representing a list of layer identifiers for layers of a track of media data that may be selected, wherein the spatially distinct data for each presentation time instance includes two or more texture frames representing different perspectives of a common video presentation, and wherein the data for the characteristics of the spatially distinct data comprises data for characteristics of the two or more texture frames, including one or more of intrinsic camera parameters including a 3×3 matrix, focal length, principal point, and skew factor or extrinsic camera parameters representing translation or rotation.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of communicating media data, the method comprising:
obtaining spatial media data including two or more channels including spatially distinct data for each presentation time instance;
generating a scene description including data describing a virtual scene, the scene description further including data grouping the spatially distinct data of the spatial media data and data for characteristics of the spatially distinct data; and
sending the scene description and the spatial media data to a receiver device.

2. The method of claim 1, wherein the spatially distinct data for each presentation time instance includes two or more texture frames representing different perspectives of a common video presentation.

3. The method of claim 2, wherein the data for the characteristics of the spatially distinct data comprises data for characteristics of the two or more texture frames, including one or more of intrinsic camera parameters including a 3×3 matrix, focal length, principal point, and skew factor or extrinsic camera parameters representing translation or rotation.

4. The method of claim 1, wherein the spatially distinct data for each presentation time instance includes two or more spatial audio frames representing different listener positions for a common audio presentation, and wherein generating the scene description comprises generating the scene description to include data representing a position at which the two or more spatial audio frames are to be presented in the virtual scene.

5. The method of claim 1, further comprising generating the scene description to include data representing a transform matrix that maps a graph node of an audio source to a speaker layout.

6. The method of claim 1, wherein obtaining the spatial media data comprises capturing the spatial media data.

7. The method of claim 1, wherein obtaining the spatial media data comprises generating the spatial media data.

8. The method of claim 1, wherein obtaining the spatial media data comprises retrieving the spatial media data.

9. The method of claim 1, wherein the data grouping the spatially distinct data of the spatial media data includes one or more of a group identifier value that indicates the two or more channels that are associated in a group, a group type value indicating whether the two or more channels are stereo channels or multi-perspective channels, and a mask value indicating whether the corresponding spatial media data are to be presented to a left side, a right side, or either side of a user.

10. The method of claim 1, wherein the data grouping the spatially distinct data includes a layers property having one or more values representing a list of layer identifiers for layers of a track of media data that may be selected.

11. A device for communicating media data, the device comprising:
a memory configured to store spatial media data; and
a processing system implemented in circuitry and configured to:
obtain the spatial media data, the spatial media data including two or more channels including spatially distinct data for each presentation time instance;
generate a scene description including data describing a virtual scene, the scene description further including data grouping the spatially distinct data of the spatial media data and data for characteristics of the spatially distinct data; and
send the scene description and the spatial media data to a receiver device.

12. The device of claim 11, wherein the data grouping the spatially distinct data of the spatial media data includes one or more of a group identifier value that indicates the two or more channels that are associated in a group, a group type value indicating whether the two or more channels are stereo channels or multi-perspective channels, and a mask value indicating whether the corresponding spatial media data are to be presented to a left side, a right side, or either side of a user.

13. The device of claim 11, wherein the data grouping the spatially distinct data includes a layers property having one or more values representing a list of layer identifiers for layers of a track of media data that may be selected.

14. The device of claim 11, wherein the spatially distinct data for each presentation time instance includes two or more texture frames representing different perspectives of a common video presentation, and wherein the data for the characteristics of the spatially distinct data comprises data for characteristics of the two or more texture frames, including one or more of intrinsic camera parameters including a 3×3 matrix, focal length, principal point, and skew factor or extrinsic camera parameters representing translation or rotation.

15. A method of communicating media data, the method comprising:
receiving spatial media data including two or more channels including spatially distinct data for each presentation time instance;
receiving a scene description including data describing a virtual scene, the scene description further including data grouping the spatially distinct data of the spatial media data and data for characteristics of the spatially distinct data;
determining a position of a user in the virtual scene; and
presenting one or more of the spatially distinct data to the user according to the position of the user in the virtual scene.

16. The method of claim 15, wherein the spatially distinct data for each presentation time instance includes two or more texture frames representing different perspectives of a common video presentation.

17. The method of claim 16, wherein presenting the one or more of the spatially distinct data comprises:
performing disparity estimation using the two or more texture frames to determine disparity information for the two or more texture frames;
performing depth map refinement using the disparity information to generate a depth map for the two or more texture frames;
performing a three-dimensional reconstruction process to generate three-dimensional objects of the two or more texture frames; and
performing reprojection of the three-dimensional objects to generate two or more views of the three-dimensional objects to be presented to the user.

18. The method of claim 17, wherein performing disparity estimation, performing depth map refinement, performing the three-dimensional reconstruction process, and performing reprojection includes using the position of the user.

19. The method of claim 17, wherein performing disparity estimation, performing depth map refinement, performing the three-dimensional reconstruction process, and performing reprojection includes using extrinsic and intrinsic camera parameters signaled in the scene description.

20. The method of claim 16, wherein the data for the characteristics of the spatially distinct data comprises data for characteristics of the two or more texture frames, including one or more of intrinsic camera parameters including a 3×3 matrix, focal length, principal point, and skew factor or extrinsic camera parameters representing translation or rotation.

21. The method of claim 16, wherein the data grouping the spatially distinct data comprises data grouping the two or more texture frames, including one or more of a group identifier value that indicates the two or more texture frames that are associated in a group, a group type value indicating whether the two or more texture frames are stereo video or multi-view video, and a mask value indicating whether the corresponding texture frames are to be presented to a left eye, a right eye, or either eye of the user.

22. The method of claim 16, wherein the data grouping the spatially distinct data comprises data grouping the two or more texture frames, including a layers property having one or more values representing a list of layer identifiers for layers of a track of media data that may be selected.

23. The method of claim 15, wherein the spatially distinct data for each presentation time instance includes two or more spatial audio frames representing different listener positions for a common audio presentation, and wherein the scene description further includes data representing a position at which the two or more spatial audio frames are to be presented in the virtual scene.

24. The method of claim 23, wherein the scene description further includes data representing a transform matrix that maps a graph node of an audio source to a speaker layout, the method further comprising mapping the two or more spatial audio frames to a position of a speaker in the virtual scene using the transform matrix.

25. The method of claim 24, wherein the transform matrix comprises T_{mapping}, the speaker comprises T_{speaker_i}, the graph node comprises T_{source_node}, Mᵢ comprises a mask for masking the two or more spatial audio frames to a left ear or a right ear of the user, and wherein mapping the two or more spatial audio frames comprises calculating T_{speaker_i}=T_{source_node}*T_{mapping}*Mᵢ.

26. The method of claim 24, wherein the transform matrix comprises T_{mapping}, the speaker comprises T_{speaker_i}, the graph node comprises T_{source_node}, and wherein mapping the two or more spatial audio frames comprises calculating T_{speaker_i}=T_{source_node} T_{mapping}.

27. The method of claim 15, wherein presenting the one or more of the spatially distinct data comprises:
determining a primary channel of the two or more channels; and
presenting only the spatially distinct data of the primary channel.

28. A device for communicating media data, the device comprising:
a memory configured to store spatial media data; and
a processing system implemented in circuitry and configured to:
receive the spatial media data, the spatial media data including two or more channels including spatially distinct data for each presentation time instance;
receive a scene description including data describing a virtual scene, the scene description further including data grouping the spatially distinct data of the spatial media data and data for characteristics of the spatially distinct data;
determine a position of a user in the virtual scene; and
present one or more of the spatially distinct data to the user according to the position of the user in the virtual scene.

29. The device of claim 28, wherein the data grouping the spatially distinct data of the spatial media data includes one or more of a group identifier value that indicates the two or more channels that are associated in a group, a group type value indicating whether the two or more channels are stereo channels or multi-perspective channels, and a mask value indicating whether the corresponding spatial media data are to be presented to a left side, a right side, or either side of the user.

30. The device of claim 28, wherein the data grouping the spatially distinct data comprises data grouping the two or more channels of the spatial media data, including a layers property having one or more values representing a list of layer identifiers for layers of a track of media data that may be selected, wherein the spatially distinct data for each presentation time instance includes two or more texture frames representing different perspectives of a common video presentation, and wherein the data for the characteristics of the spatially distinct data comprises data for characteristics of the two or more texture frames, including one or more of intrinsic camera parameters including a 3×3 matrix, focal length, principal point, and skew factor or extrinsic camera parameters representing translation or rotation.
